(19) United States
(12) Patent Application Publication
(10) Pub. No.: US 2014/0052879 A1
(43) Pub. Date: Feb. 20, 2014

(54) PROCESSOR, INFORMATION PROCESSING APPARATUS, AND INTERRUPT CONTROL METHOD

(71) Applicant: FUJITSU LIMITED, Kawasaki-shi (JP)

(72) Inventor: Koken Shimizuno, Kawasaki (JP)

(21) Appl. No.: 13/922,288

(22) Filed: Jun. 20, 2013

(30) Foreign Application Priority Data
Aug. 14, 2012 (JP) 2012-179921

(51) Int. Cl. G06F 13/24

(52) U.S. Cl. CPC G06F 13/24
USPC 710/50

(57) ABSTRACT

An input/output interface unit includes a plurality of ports connected to different external units, and adds predetermined identification information unique to each of the ports to an interrupt request received from each of the external units via the ports. An interrupt control unit stores information on the interrupt request received by the input/output interface unit in a vector storage unit based on the identification information. Each of cores executes a process corresponding to the interrupt request stored in the vector storage unit based on the identification information.

### CROSS-REFERENCE TO RELATED APPLICATION

This application is based upon and claims the benefit of priority of the prior Japanese Patent Application No. 2012-179921, filed on Aug. 14, 2012, the entire contents of which are incorporated herein by reference.

### FIELD

The embodiment discussed herein is directed to a processor, an information processing apparatus, and an interrupt control method.

### BACKGROUND

An information processing apparatus that executes various programs performs interrupt processing to suspend a running process and execute another process in response to a processing request from an external unit that is an I/O (Input Output) device, such as a hard disk.

For example, a Central Processing Unit (CPU) as a processor is connected to the external unit via an I/O bus. An interrupt (IO-INT: Input Output INTerrupt) from the external unit is sent to an interrupt control unit in the CPU via an input/output interface, such as a Peripheral Component Interconnect (PCI) Express. If the CPU includes a plurality of cores, the interrupt is sent from the interrupt control unit to the cores.

As a conventional CPU, for example, a CPU configured as illustrated in FIG. 13 has been used. FIG. 13 is a diagram illustrating an example of the conventional CPU. A CPU 900 includes an input/output interface 910, an interrupt control unit 920, and cores 930. A single external unit 940 is connected to the input/output interface 910. The interrupt control unit 920 includes an external-unit interrupt vector register 921 serving as a register that determines a vector of an interrupt from the external unit 940 and an interrupt-request vector register 922 serving as a register that manages a flag of each vector. The vector is a value indicating a priority order of interrupts. The external-unit interrupt vector register 921 stores therein a vector value corresponding to an interrupt upon reception of the interrupt from the external unit 940. The interrupt sent from the external unit 940 to the CPU 900 via an external interface is received by the input/output interface 910. Thereafter, the external-unit interrupt vector register 921 of the interrupt control unit 920 determines a vector value of the interrupt from the external unit 940. By contrast, in the case of an inter-core interrupt that is an interrupt between cores, a vector is designated and sent by a core serving as a source of an interrupt request.

The interrupt-request vector register 922 manages a value of a flag for each of the cores 930 and for each of the vectors. Specifically, when an inter-core interrupt or an interrupt from an external unit occurs, the interrupt control unit 920 sets the interrupt in the position of a designated vector in a designated storage area within the storage area of each of the cores 930 in the interrupt-request vector register 922.

Upon receiving an interrupt notice from the interrupt control unit 920, the core 930 reads an interrupt with a vector having higher priority from among interrupts stored in the interrupt-request vector register 922 according to an instruction from an Operation System (OS). Specifically, the priority order is determined in advance according to the vector values, and a corresponding one of the cores 930 reads a vector value with the highest priority at this time from among the vectors managed for each of the cores 930. The core 930 determines a type of the interrupt, such as whether the interrupt is an interrupt from the external unit 940 or an inter-core interrupt, based on the read value of the interrupt vector, and reads data. The vector in the interrupt-request vector register 922 is reset at the same time as the vector is read.

As an interrupt process, a conventional technology is known, in which what external unit has issued an interrupt is recorded by software in a relay circuit in a chip set, and when an interrupt is notified, the external unit that has issued the interrupt is identified by using information recorded at the time of relay (see, for example, Japanese Laid-open Patent Publication No. 2010-250453).

However, the conventional interrupt technology is based on the assumption that an interrupt occurs in an environment in which one external unit is connected to a CPU. Therefore, when a plurality of external units are connected to one CPU, it has been difficult to distinguish which one of the external units has issued an interrupt.

Furthermore, in the conventional technology for recording information on the external unit that has issued an interrupt, it is needed to add, by software, information indicating which one of the external units has issued an interrupt and thereafter to perform a process for identifying the external unit by using the information added by the software. Therefore, in the conventional technology, the configuration of the software becomes complicated in order to identify an external unit that has issued an interrupt from among the external units connected to a CPU, and therefore, it is difficult to realize such functions.

### SUMMARY

According to an aspect of an embodiment, a processor includes an input/output interface unit that includes a plurality of ports each being connected to a different external unit, and that adds predetermined identification information unique to each of the ports to an interrupt request received from each of the external units via the ports; an interrupt control unit that stores information on the interrupt request received by the input/output interface unit in a register based on the identification information; and a process executing unit that executes a process corresponding to the interrupt request stored in the register based on the identification information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an information processing apparatus according to an embodiment;

FIG. 2 illustrates connections between CPUs;

FIG. 3 is a block diagram of a CPU according to the embodiment;

FIG. 4 is a diagram illustrating an example of a packet used for an interrupt request;

FIG. 5 is a block diagram illustrating details of an input/output interface unit;

FIG. 6 is a diagram for explaining a relation between an input/output port and a vector;

FIG. 7 is a diagram illustrating an example of an interrupt request packet to which a vector value is added;

FIG. 8 is a block diagram illustrating details of an interrupt control unit;

FIG. 9 is a diagram illustrating an example of an interrupt-request vector register;

FIG. 10 is a diagram illustrating a packet to which a vector is added;

FIG. 11 is a flowchart of an interrupt control process with respect to an interrupt request from an external unit;

FIG. 12 is a flowchart of an interrupt control process with respect to an inter-core interrupt request; and

FIG. 13 is a diagram illustrating an example of a conventional CPU.

### DESCRIPTION OF EMBODIMENTS

Preferred embodiments of the present invention will be explained with reference to accompanying drawings.

The present invention is not limited by the embodiments below.

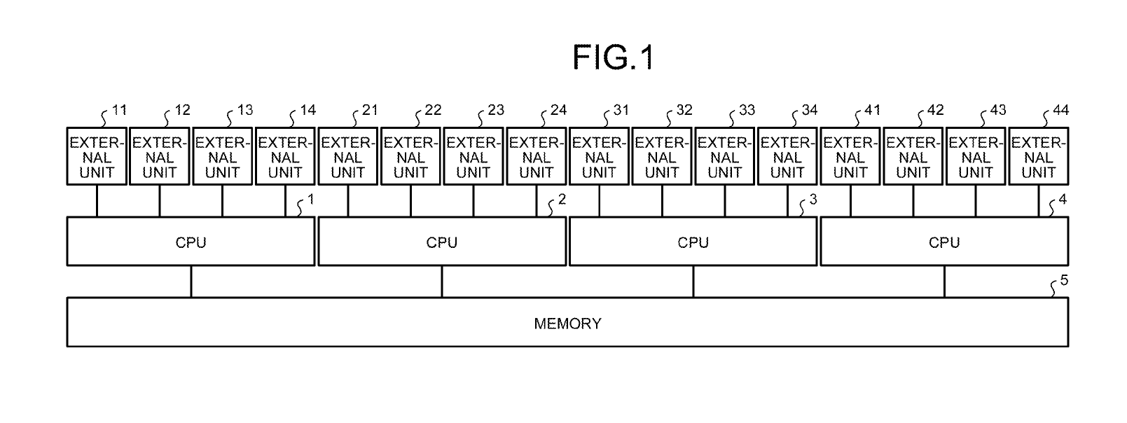

FIG. 1 is a configuration diagram of an information processing apparatus according to an embodiment. The information processing apparatus according to the embodiment includes CPUs 1 to 4, a memory 5, and external units 11 to 14, 21 to 24, 31 to 34, and 41 to 44.

The CPUs 1 to 4 are processors connected to the memory 5. The external units 11 to 14 are connected to the CPU 1 via a PCI Express as an interface. Similarly, the external units 21 to 24 are connected to the CPU 2, the external units 31 to 34 are connected to the CPU 3, and the external units 41 to 44 are connected to the CPU 4.

The external units 11 to 14 output interrupt requests to the CPU 1. The external units 21 to 24 output interrupt requests to the CPU 2. The external units 31 to 34 output interrupt requests to the CPU 3. The external units 41 to 44 output interrupt requests to the CPU 4.

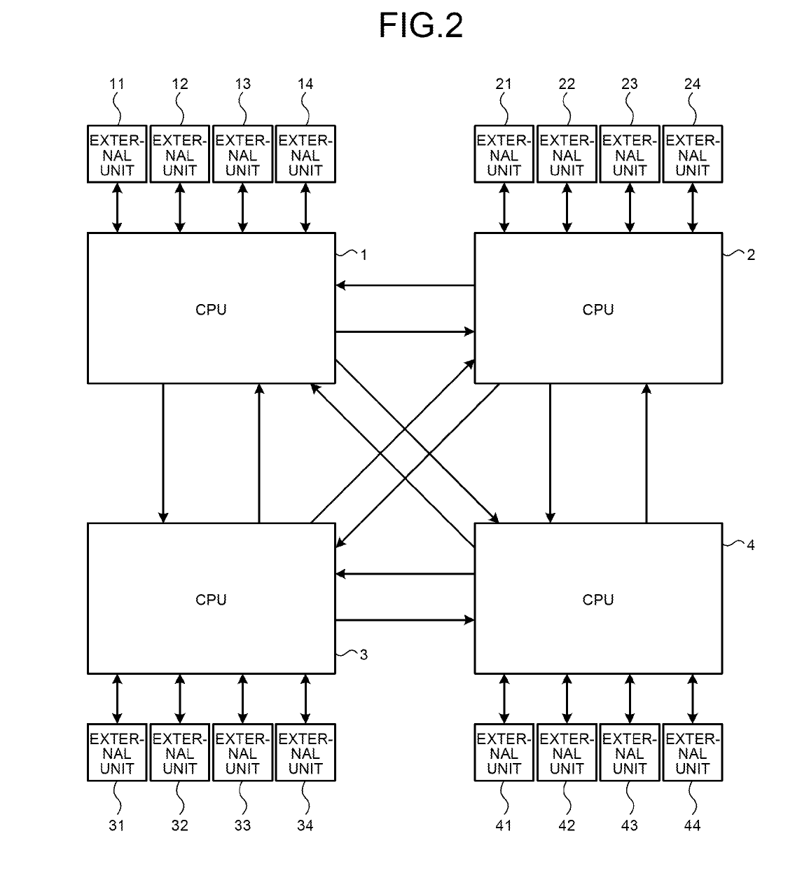

In FIG. 1, connections between the CPUs 1 to 4 are not illustrated for simplicity's sake. Therefore, the connections between the CPUs 1 to 4 will be explained below with reference to FIG. 2. FIG. 2 illustrates the connections between the CPUs.

As illustrated in FIG. 2, the CPUs 1 to 4 are connected to one another. The CPUs 1 to 4 can transmit and receive data from one to the others. Details of the CPUs 1 to 4 will be explained below. The CPUs 1 to 4 have the same configuration in the embodiment; therefore, the CPU 1 will be explained by way of example. The same configuration and functions explained below are applied to the CPUs 2 to 4.

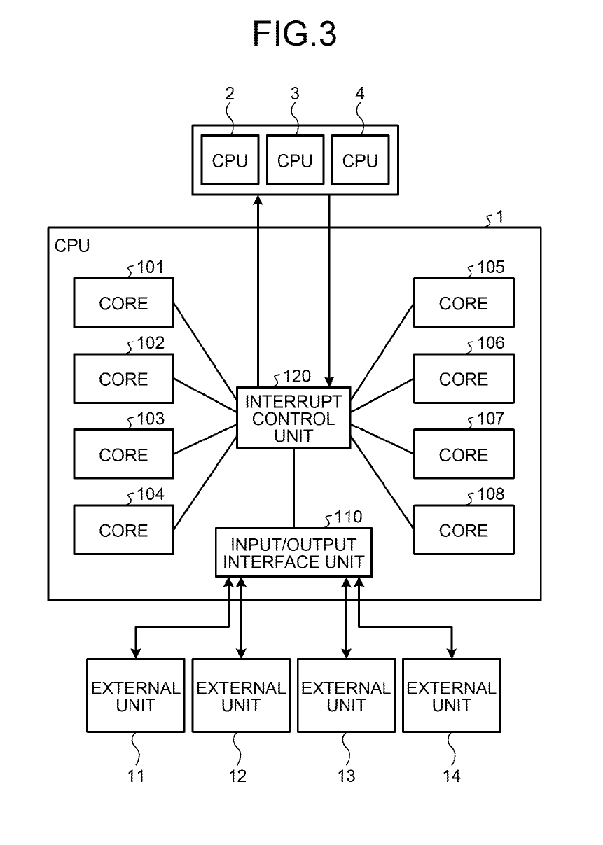

FIG. 3 is a block diagram of the CPU according to the embodiment. As illustrated in FIG. 3, the CPU 1 includes cores 101 to 108, an input/output interface unit 110, and an interrupt control unit 120. In the following, any of the cores 101 to 108 may simply be described as a core 100 when the cores 101 to 108 are not distinguished from one to the other.

The input/output interface unit 110 is connected to the external units 11 to 14. The interrupt control unit 120 is connected to interrupt control units of the CPUs 2 to 4. In FIG. 3, illustrations of the interrupt control units of the CPUs 2 to 4 are omitted.

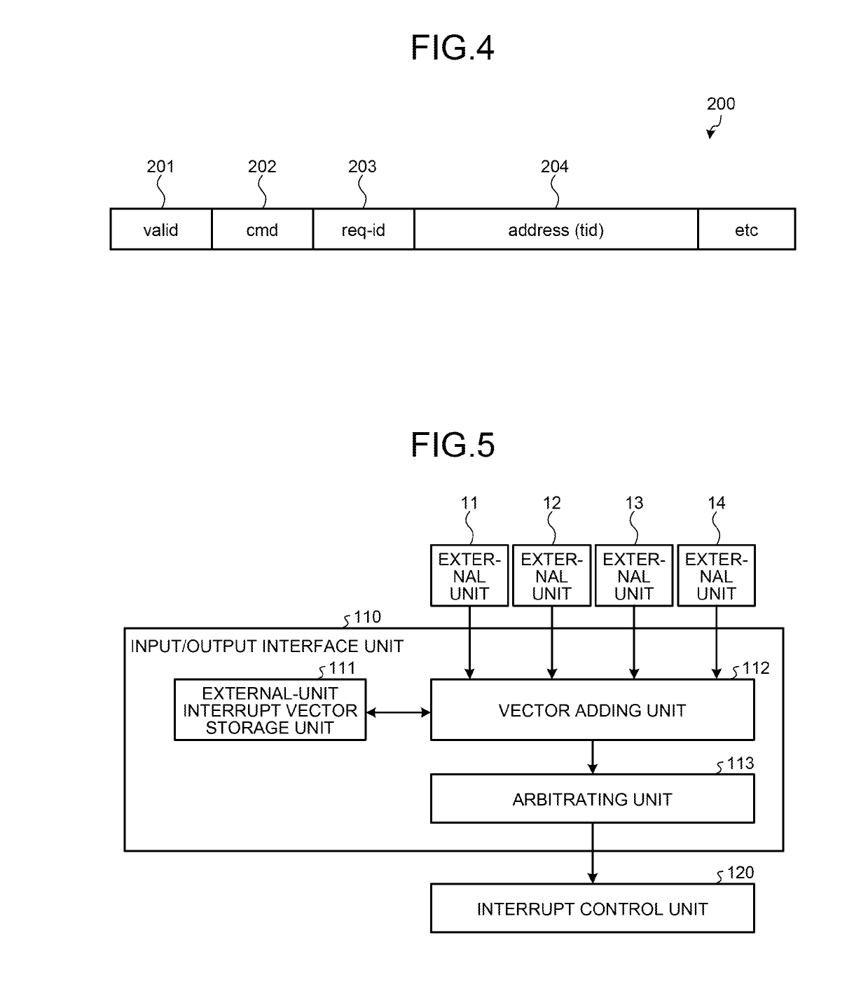

The external units 11 to 14 transmit interrupt request packets as illustrated in FIG. 4 to the input/output interface unit 110. FIG. 4 is a diagram illustrating an example of a packet used for an interrupt request.

As illustrated in FIG. 4, an interrupt request packet 200 stores therein valid 201, cmd 202, request (req)-Identification (id) 203, address 204, and other information. The valid 201 is information indicating whether a packet is valid or invalid. The command (cmd) 202 is information indicating a type of a packet request. Specifically, in the case of the interrupt request packet, the cmd 202 is information indicating that the packet is an interrupt request. In the interrupt requests transmitted by the external units 11 to 14, the cmd 202 is a value indicating the interrupt request transmitted by the external units. The req-id 203 is an identifier of the packet. For example, a CPU number and a core number of a source of the packet are stored in the req-id 203. In the address 204, an address to be referred to for performing interrupt is written. In the address 204, target-identification (tid) indicating a CPU number and a core number of a destination of the packet is stored.

FIG. 5 is a block diagram illustrating details of the input/output interface unit. As illustrated in FIG. 5, the input/output interface unit 110 includes an external-unit interrupt vector storage unit 111, a vector adding unit 112, and an arbitrating unit 113.

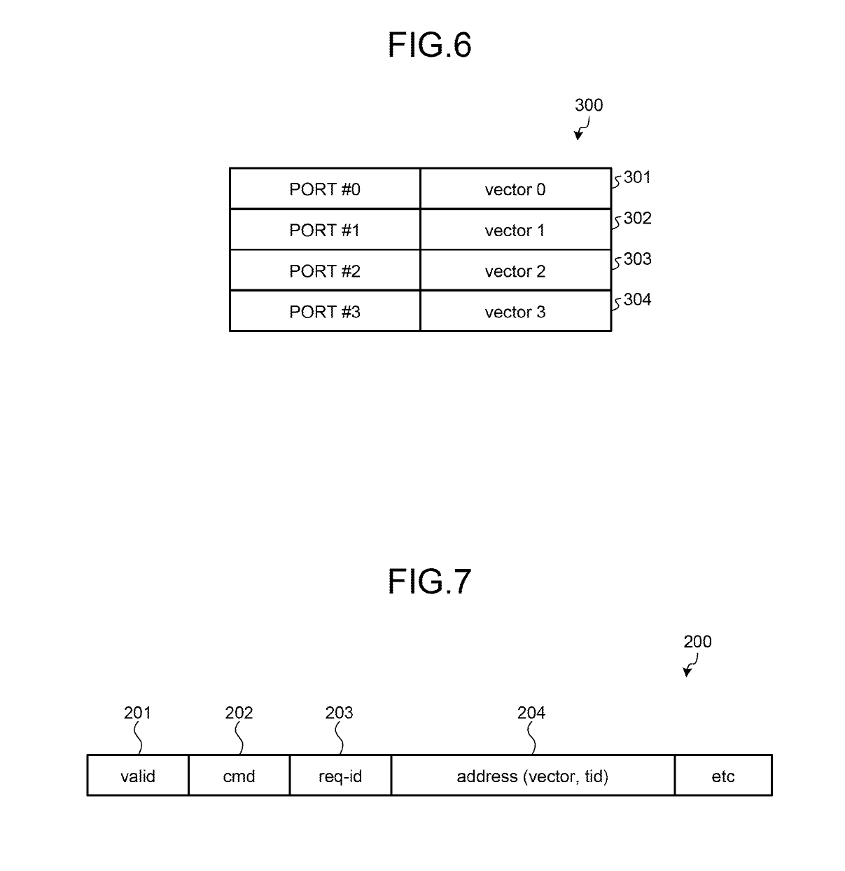

FIG. 6 is a diagram for explaining a relation between an input/output port and a vector. As illustrated in a correspondence table 300 in FIG. 6, the external-unit interrupt vector storage unit 111 stores therein, in advance, vector values corresponding to ports, for each of input/output ports serving as PCI express interfaces. The vector is information indicating priority of an interrupt request and a transmission source of the interrupt request. For example, the vector is represented by a value in a range from 0 to 63, and the priority becomes higher as the value increases. Furthermore, for example, different values are assigned to the vectors of an inter-core interrupt request and an interrupt request from an external unit. Therefore, it is possible to distinguish whether an interrupt request is issued by the other cores or by the external units based on the vector added to the interrupt request.

In FIG. 6, a vector 0 as a vector corresponding to a port #0 is stored in a field 301. A vector 1 as a vector corresponding to a port #1 is stored in a field 302.

A vector 2 as a vector corresponding to a port #2 is stored in a field 303. A vector 3 as a vector corresponding to a port #3 is stored in a field 304. While the vectors corresponding to the respective ports are represented by the vectors 0 to 3 in this example, arbitrary values in a range from 0 to 63 in particular are assigned as the vectors 0 to 3 in the embodiment.

Vectors assigned to the respective ports by the external-unit interrupt vector storage unit 111 of each of the CPUs 1 to 4 are determined so that the vectors become different between the external-unit interrupt vector storage units 111 of the CPUs 1 to 4. For example, when the external-unit interrupt vector storage unit 111 of the CPU 1 employs the vectors 0 to 3, the external-unit interrupt vector storage units 111 of the CPUs 2 to 4 do not employ the vectors 0 to 3.

The vector adding unit 112 includes an input/output port as a PCI-express interface. For example, the vector adding unit 112 includes four PCI-express input/output ports. It is assumed here that an input/output port to which the external unit 11 is connected is the port #0, an input/output port to which the external unit 12 is connected is the port #1, an input/output port to which the external unit 13 is connected is a port #4, and an input/output port to which the external unit 14 is connected is a port #5.

The vector adding unit 112 receives an interrupt request packet from any of the external units 11 to 14. The vector adding unit 112 acquires, from the external-unit interrupt vector storage unit 111, a vector corresponding to the input/output port through which the interrupt request is received. For example, when the interrupt request packet is transmitted from the external unit 11, the vector adding unit 112 receives the packet via the input/output port of the port #0. In this case, the vector adding unit 112 acquires the vector 0, as the vector corresponding to the port #0, by using a correspondence relation stored in the external-unit interrupt vector storage unit 111 as illustrated in FIG. 6.

The vector adding unit 112 adds the acquired vector to the received interrupt request packet. FIG. 7 is a diagram illustrating an example of the interrupt request packet to which a vector value is added. As illustrated in FIG. 7, in the embodiment, the vector adding unit 112 adds a value representing a vector to the interrupt request packet 200, by using a bit of the address 204 of the interrupt request packet 200. The bit of the address 204 used to add the vector is determined in advance. While the vector is embedded in the address 204 in the embodiment, other methods may be employed. For example, the vector may be embedded in other information.

The vector adding unit 112 outputs the interrupt request packet, to which the vector indicating the input/output port that has received the packet is added, to the arbitrating unit 113.

The arbitrating unit 113 receives the interrupt request packet, to which the vector indicating the input/output port that has received the packet is added, from the vector adding unit 112. The arbitrating unit 113 outputs each of the interrupt request packets to the interrupt control unit 120 while adjusting timings so as to prevent collision of the interrupt request packets.

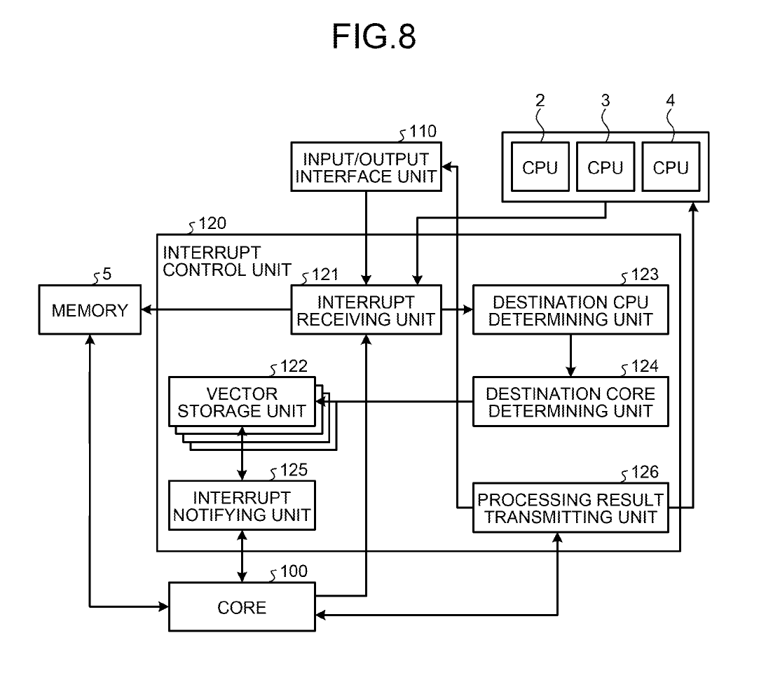

FIG. 8 is a block diagram illustrating details of the interrupt control unit. As illustrated in FIG. 8, the interrupt control unit 120 includes an interrupt receiving unit 121, a vector storage unit 122, a destination CPU determining unit 123, a destination core determining unit 124, an interrupt notifying unit 125, and a processing result transmitting unit 126.

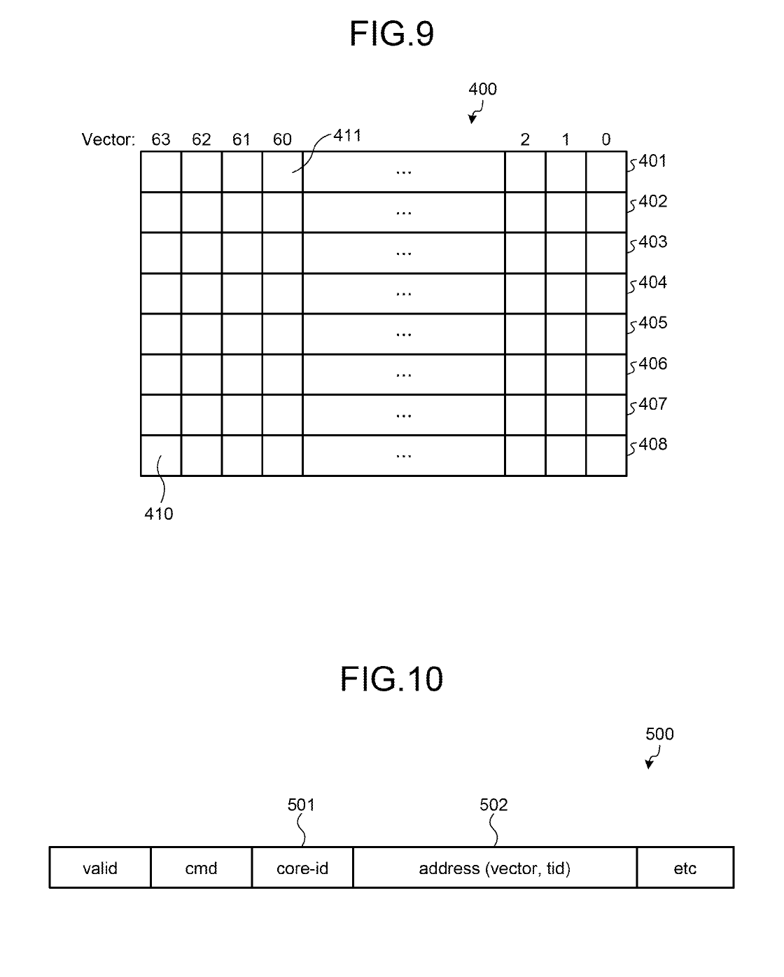

The vector storage unit 122 includes an interrupt-request vector register 400 as illustrated in FIG. 9 for example. FIG. 9 is a diagram illustrating an example of the interrupt-request vector register. The interrupt-request vector register 400 stores therein presence or absence of an interrupt request for each of the cores 101 to 108. The interrupt-request vector register 400 also stores therein interrupt requests such that priorities are indicated by the vectors.

For example, a register 401 of the interrupt-request vector register 400 is a register for storing presence or absence of an interrupt for the core 101. Similarly, registers 402 to 408 are registers for storing presence or absence of interrupt requests for the respective cores 102 to 108. Each of the registers 401 to 408 includes sixty-four flag storage fields. Flag storage fields 410 of each of the registers 401 to 408 correspond to the respective vector values. In the embodiment, because the vectors of 0 to 63 are employed, each of the registers 401 to 408 has the sixty-four flag storage fields 410. In FIG. 9, to make the understanding easy, the vector values are illustrated in an upper portion so as to correspond to the respective flag storage fields 410 of the registers 401 to 408. For example, the register 401 is a 64-bit register, and each of the bits corresponds to one of the flag storage fields 410. Information indicating ON or OFF of a flag is stored in each of the flag storage fields 410. For example, when an interrupt request with a vector value of 60 is generated with respect to the core 101, a flag in a flag storage field 411 corresponding to the vector value of 60 in the register 401 is set to ON. For example, when the flag storage fields 410 of the register 401 are represented by 1 bit, ON/OFF of the flag is represented such that the flag is OFF when a corresponding bit among the bits is 0 and the flag is ON when the bit is 1.

In FIG. 8, the vector storage unit 122 is illustrated such that it includes a plurality of units. This indicates that registers are provided for the respective cores 101 to 108.

The interrupt receiving unit 121 receives an interrupt request packet sent by any of the external units 11 to 14 via the input/output interface unit 110.

The interrupt receiving unit 121 also receives an interrupt request packet that the core 100 has output to any of the other cores of the CPU 1.

When the core 100 generates an inter-core interrupt request packet that is an interrupt request to the other cores, the core 100 adds a vector to the packet. For example, the core 100 generates an interrupt request packet such as a packet 500 as illustrated in FIG. 10. FIG. 10 is a diagram illustrating a packet to which a vector is added. In this case, the core 100 embeds a vector in a predetermined position in an address 502. In the embodiment, it is assumed that a position in which a vector is embedded in an inter-core interrupt request by the core 100 and a position in which a vector is embedded in an interrupt request from an external unit by the vector adding unit 112 are the same. A core-id 501 of the packet 500 is information indicating a destination core number.

The interrupt receiving unit 121 receives an interrupt request packets from any of the CPUs 2 to 4. The interrupt request received from any of the CPUs 2 to 4 may be an interrupt request from an external unit or may be an inter-core interrupt request. In the case of the interrupt request from the external unit, the interrupt receiving unit 121 receives a packet in the form of the packet 200 as illustrated in FIG. 7. In the case of the interrupt request from another core, the interrupt receiving unit 121 receives a packet in the form of the packet 500 as illustrated in FIG. 10.

The interrupt receiving unit 121 outputs the received interrupt request packet to the destination CPU determining unit 123.

The interrupt receiving unit 121 receives data used with the received interrupt request from interrupt request source, such as any of the external units 11 to 14, the cores 101 to 108, and the CPUs 2 to 4. The interrupt receiving unit 121 stores the received data in the memory 5.

The destination CPU determining unit 123 receives the interrupt request packet from the interrupt receiving unit 121. The destination CPU determining unit 123 checks tid stored in an address area of the received interrupt request packet, and acquires a destination CPU number.

When the destination CPU number indicates own CPU, the destination CPU determining unit 123 outputs the interrupt request packet to the destination core determining unit 124. On the other hand, when the destination CPU number indicates a CPU other than the own CPU, the destination CPU determining unit 123 transmits the interrupt request packet to the interrupt control unit 120 of a CPU corresponding to the destination CPU number among the CPUs 2 to 4.

The destination core determining unit 124 receives the interrupt request packet from the destination CPU determining unit 123. The destination core determining unit 124 checks tid stored in an address area of the received interrupt request packet, and acquires the destination core number.

The destination core determining unit 124 selects a register corresponding to a core indicated by the acquired destination core number from among the interrupt-request vector registers included in the vector storage unit 122. Subsequently, the destination core determining unit 124 acquires a vector stored in an address area of the received interrupt request packet. The destination core determining unit 124 sets a flag to ON in a flag storage field corresponding to the acquired vector of the selected register. Consequently, the destination core determining unit 124 stores, in the vector storage unit 122, information indicating that an interrupt request with priority indicated by the vector has been generated with respect to the destination core number.

The interrupt notifying unit 125 checks ON/OFF of the flag in the interrupt-request vector register of the vector storage unit 122, and detects occurrence of an interrupt request with respect to each of the cores 101 to 108. The interrupt notifying unit 125 sends a notice of the interrupt request to the core 100 corresponding to the register via a leased line.

Upon receiving the notice indicating reception of the interrupt request from the core 100, the interrupt notifying unit 125 sends a notice of an address of the memory 5 storing data used to execute a process corresponding to the interrupt request, to the core 100 that has received the interrupt request. Thereafter, when the core 100 receives the interrupt request, the interrupt notifying unit 125 reads the vector indicating a priority order from the core 100. In this case, the interrupt control unit 120 selects a register corresponding to the core 100 that has received the interrupt request from among the interrupt-request vector registers stored in the vector storage unit 122. The interrupt control unit 120 sends, to the core 100, a vector value that has the highest priority at the time the vector value is read from the selected register. Thereafter, the interrupt control unit 120 resets the vector value read by the core 100. For example, the interrupt notifying unit 125 sets the flag corresponding to the interrupt request received by the selected register to OFF, so that the vector value is reset.

The interrupt notifying unit 125 notifies the cores 101 to 108 of the interrupt requests until no interrupt request is left with respect to the cores 101 to 108 of the interrupt-request vector registers stored in the vector storage unit 122.

The processing result transmitting unit 126 receives a result of an interrupt process from the core 100. The processing result transmitting unit 126 transmits the received result of the interrupt process to a request source, such as the CPUs 2 to 4, that has requested the interrupt process. For example, when the interrupt process is requested by the external unit 11, the processing result transmitting unit 126 transmits a result of the process to the external unit 11 via the input/output interface unit 110.

Incidentally, conventional interrupt control has involved data; therefore, the number of interrupts that can be received simultaneously are limited. Therefore, in some cases, the CPU 1 gets busy and an interrupt failure, such as a failure to receive an interrupt request, may occur. In recent years, however, the CPU 1 exchanges data via the memory 5 while the interrupt control unit 120 only exchanges a vector serving as a flag. Therefore, the frequency of failures is reduced and a reply to the interrupt request from the interrupt control unit 120 becomes a notice of success. Furthermore, when an interrupt occurs with respect to a vector whose flag is already set to ON, it is difficult for hardware, such as the CPU 1, to discriminate between the interrupts. Therefore, the hardware ignores the interrupt request. In this case, software has the responsibility of setting the vector to an exclusive value.

When issuing an interrupt request to any of other cores, the core 100 generates an inter-core interrupt request packet with respect to the other CPU. At this time, the core 100 adds a vector to the interrupt request packet. The core 100 outputs the generated interrupt request packet to the interrupt control unit 120.

The core 100 receives a notice of the interrupt request from the interrupt notifying unit 125. When receiving the interrupt request, the core 100 notifies the interrupt notifying unit 125 that the core 100 receives the interrupt request, and notifies the interrupt control unit 120 to read a vector.

The core 100 receives, from the interrupt control unit 120, a vector value with the highest priority when the vector is read. The core 100 identifies which one of the external units 11 to 14, 21 to 24, 31 to 34, and 41 to 44 or which one of the cores 101 to 108 of the CPUs 1 to 4 has sent the interrupt request, that is, a request source, based on the vector value of the interrupt request received from the interrupt control unit 120.

A unique vector is assigned to each of the external units 11 to 14, 21 to 24, 31 to 34, and 41 to 44. Therefore, the core 100 can easily identify which one of the external units has issued the interrupt request based on the vector value.

If the vector is other than the vectors assigned to the external units, the core 100 can recognize that the notified interrupt request is an interrupt request sent by any one of the other cores. The core 100 can also identify which one of the cores of the CPUs has sent the notified interrupt request based on the vector value.

The core 100 acquires data at the address of the memory 5 corresponding to the received vector. The core 100 performs a process corresponding to a request source of the identified interrupt request by using the acquired data. Thereafter, the core 100 outputs a result of the process to the processing result transmitting unit 126 of the interrupt control unit 120.

In the embodiment, the core 100 identifies a request source of the interrupt request based on the vector value regardless of whether the request source is an internal device or an external device. However, other methods may be employed for the identification. For example, the interrupt control unit 120 or the like may store source information or a data address, such as a source CPU number or a source core number, for each vector, and the core 100 may identify a source of the interrupt request by using the information. In this case, however, hardware resources are largely consumed.

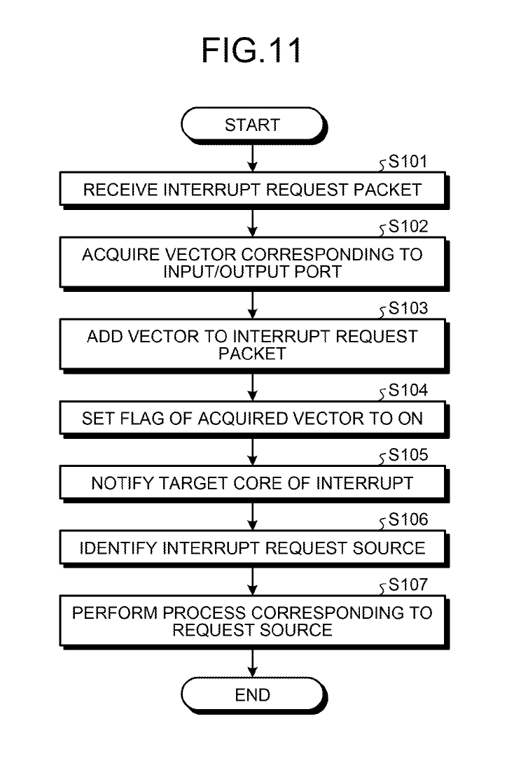

With reference to FIG. 11, an interrupt control process that an interrupt control circuit according to the embodiment performs with respect to the interrupt request from the external unit will be explained. FIG. 11 a flowchart of the interrupt control process with respect to the interrupt request from the external unit.

The vector adding unit 112 of the input/output interface unit 110 receives an interrupt request packet from any of the external units 11 to 14 (Step S101).

The vector adding unit 112 acquires a vector corresponding to the input/output port through which the interrupt request has been input, from the external-unit interrupt vector storage unit 111 (Step S102).

The vector adding unit 112 adds the acquired vector to the interrupt request packet (Step S103). The vector adding unit 112 transmits the interrupt request packet with the added vector to the arbitrating unit 113. The arbitrating unit 113 transmits the interrupt request packet to the interrupt control unit 120 while adjusting a timing so as to prevent collision of interrupt request packets.

The destination CPU determining unit 123 of the interrupt control unit 120 receives the interrupt request packet from the input/output interface unit 110 via the interrupt receiving unit 121. The destination CPU determining unit 123 outputs the interrupt request packet to the CPU designated by the interrupt request packet. In this example, it is assumed that own CPU is designated by the interrupt request. Therefore, the destination CPU determining unit 123 outputs the interrupt request packet to the destination core determining unit 124. The destination core determining unit 124 identifies the core designated by the received interrupt request packet, and acquires a vector of the interrupt request. The destination core determining unit 124 sets a flag of the acquired vector in a register corresponding to the identified core to ON among the interrupt-request vector registers stored in the vector storage unit 122, and writes information indicating that the interrupt request for the designated vector is issued (Step S104).

The interrupt notifying unit 125 determines whether an interrupt request has issued with respect to each of the cores 100 from the interrupt-request vector registers stored in the vector storage unit 122. The interrupt notifying unit 125 sends a notice of the interrupt to the core 100 as a subject of the interrupt request (Step S105). The core 100 sends a request to read a vector to the interrupt control unit 120. The interrupt control unit 120 receives the request to read the vector from the notified core 100. The interrupt control unit 120 sends, as a reply, a vector value with the highest priority at the time of reception of the interrupt request to the core 100. At this time, the interrupt control unit 120 resets the flag of the vector in the register that has sent the reply to the core 100.

The core 100 identifies a request source of the interrupt request from among the external units 11 to 14 based on the received vector value (Step S106).

The core 100 acquires data based on the received vector value and performs a process corresponding to the request source that is identified as the source of the interrupt request (Step S107). In the flow illustrated in FIG. 11, a process for a single interrupt request is explained. In actuality, when a plurality of flags are ON in the register, that is, when a plurality of interrupt requests are issued, the interrupt control unit 120 continuously sends the interrupt notice to the core 100.

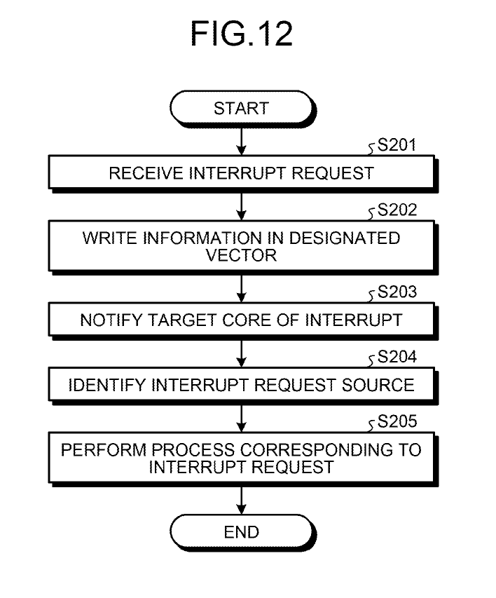

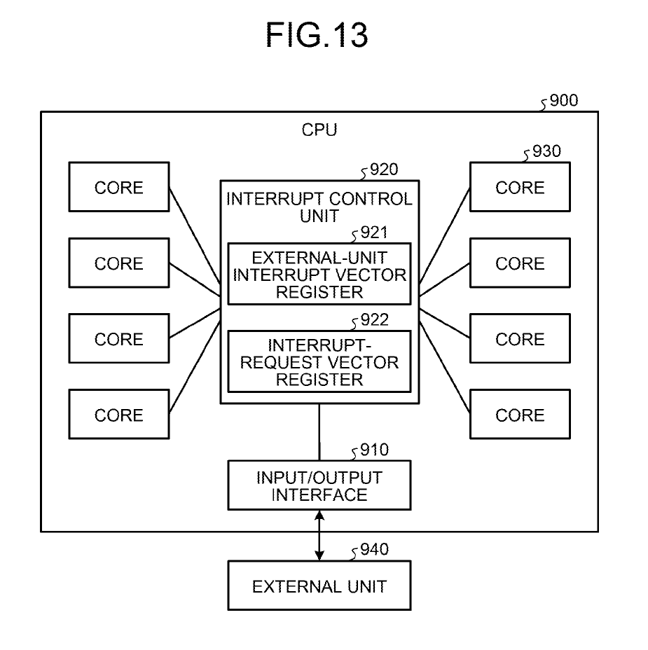

With reference to FIG. 12, an interrupt control process that the interrupt control circuit of the embodiment performs with respect to the inter-core interrupt request will be explained. FIG. 12 is a flowchart of the interrupt control process with respect to the inter-core interrupt request.

The interrupt receiving unit 121 of the interrupt control unit 120 receives an interrupt request packet from the core 100 (Step S201). The interrupt receiving unit 121 sends the received interrupt request packet to the destination CPU determining unit 123.

The destination CPU determining unit 123 receives the interrupt request packet from the interrupt receiving unit 121. The destination CPU determining unit 123 outputs the interrupt request packet to the CPU designated by the interrupt request packet. In this example, it is assumed that own CPU is designated by the interrupt request. Therefore, the destination CPU determining unit 123 outputs the interrupt request packet to the destination core determining unit 124. The destination core determining unit 124 identifies the core designated by the received interrupt request packet, and acquires a vector of the interrupt request. The destination core determining unit 124 sets a flag of the acquired vector in the register corresponding to the identified core to ON among the interrupt-request vector registers stored in the vector storage unit 122, and writes information indicating that the interrupt request for the designated vector is issued (Step S202).

The interrupt notifying unit 125 determines whether an interrupt request has issued with respect to each of the cores 100 from the interrupt-request vector registers stored in the vector storage unit 122. The interrupt notifying unit 125 sends a notice of the interrupt to the core 100 as a subject of the interrupt request (Step S203). The core 100 sends a request to read a vector to the interrupt control unit 120. The interrupt control unit 120 receives the request to read the vector from the core 100. The interrupt control unit 120 sends, as a reply, a vector value with the highest priority at the time of reception of the interrupt request to the core 100. At this time, the interrupt control unit 120 resets the flag of the vector in the register that has sent the reply to the core 100.

The core 100 identifies a request source of the interrupt request based on the received vector value (Step S204).

The core 100 acquires data at the address based on the received vector value, and performs a process corresponding to the request source that is identified as the source of the interrupt request (Step S205).

As described above, the interrupt control circuit according to the embodiment adds a vector corresponding to the input/output port through which the interrupt request has been received to the received interrupt request, and stores the interrupt request with the vector in the register. The core identifies the external unit that has issued the interrupt request by using the vector of the interrupt request, and performs a process corresponding to the identified external unit. In this way, the interrupt control circuit of the embodiment can easily identify the external unit that has issued the interrupt request.

Furthermore, the vector that is information conventionally added to the interrupt request to indicate priority of an interrupt is used as information for identifying the external unit. Therefore, it is possible to add a specific function to the external unit by only slightly modifying the conventional interrupt control circuit. Specifically, as a process performed by software, the specific function of the external unit can be realized by only adding a process for setting a vector value for each port. By contrast, in the conventional technology in which identification information is added to an interrupt request by software and an external unit is identified by using the identification information that is added when the interrupt request is processed, it is needed to perform all of the processes by software and a number of additional functions or modifications are needed in the software. As described above, the interrupt control circuit according to the embodiment can easily add the specific function to the external unit and can reduce manufacturing costs compared with the conventional technology.

In the above descriptions, it is explained that data corresponding to the interrupt request from the external units 11 to 14 is stored in the memory 5, and the core 100 reads the data from the memory 5 to execute a process. However, the data may be stored in other locations. For example, if data corresponding to the interrupt request from the external units 11 to 14 is small and the number of the interrupt requests is also small, the interrupt control unit 120 may store data, may receive a notice of reception of the interrupt request from the core 100, and may transmit the data to the core 100.

According to one aspect of the processor, the information processing apparatus, and the interrupt control method disclosed in the present invention, it is possible to easily identify an external unit that has issued an interrupt request.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A processor comprising:
an input/output interface unit that includes a plurality of ports each being connected to a different external unit, and that adds predetermined identification information unique to each of the ports to an interrupt request received from each of the external units via the ports;
an interrupt control unit that stores information on the interrupt request received by the input/output interface unit in a register based on the identification information; and
a process executing unit that executes a process corresponding to the interrupt request stored in the register based on the identification information.

2. The processor according to claim 1, further comprising a plurality of the process executing units, wherein
the interrupt control unit stores information on the interrupt request in a register corresponding to a process executing unit designated by the received interrupt request, and sends a notice of the interrupt request to the process executing unit corresponding to the register according to a priority order contained in the identification information of the interrupt request stored in the register, and
the process executing unit sequentially performs processes corresponding to the interrupt requests notified by the interrupt control unit.

3. The processor according to claim 1, wherein when a process by another interrupt control circuit is designated by the received interrupt request, the interrupt control unit transmits the received interrupt request to the designated interrupt control circuit.

4. The processor according to claim 1, wherein the interrupt control unit sets a flag indicating that the interrupt request with added identification information is received, at the position allocated for the identification information in the register.

5. The processor according to claim 1, wherein the interrupt control unit receives an interrupt request to which the identification information is added from another interrupt control circuit, and stores information on the received interrupt request in the register based on the identification information added to the received interrupt request.

6. An information processing apparatus comprising:
a CPU; and
a plurality of external units, wherein
the CPU includes:
an input/output interface unit that includes a plurality of ports connected to the respective external units, and that adds identification information unique to each of the ports to an interrupt request received via each of the ports;
an interrupt control unit that stores information on the interrupt request received by the input/output interface unit in a register based on the identification information; and
a process executing unit that executes a process corresponding to the interrupt request stored in the register based on the identification information, and
each of the external units is connected to a different port.

7. An interrupt control method comprising:
adding predetermined identification information unique to each of ports to an interrupt request received from each of different external units via a plurality of ports connected to the respective external units;
storing information on the received interrupt request in a register based on the identification information; and
executing a process corresponding to the interrupt request stored in the register based on the identification information.
